(19) United States
(12) Patent Application Publication
(10) Pub. No.: US 2012/0225414 A1
(43) Pub. Date: Sep. 6, 2012

(54) METHOD AND APPARATUS FOR TEACHING BIOLOGY USING VIRTUAL LIVING ORGANISM

(75) Inventors: SUNG-HA KIM, Gongju-si (KR); SANG-KEUN YOO, SEOUL (KR)

(73) Assignee: KOREA NATIONAL UNIVERSITY OF EDUCATION INDUSTRY-ACADEMY COOPRATION FOUNDATION, CHEONGWON-GUN (KR)

(21) Appl. No.: 13/410,255

(22) Filed: Mar. 1, 2012

(30) Foreign Application Priority Data
Mar. 3, 2011 (KR) 10-2011-0019086

(51) Int. Cl. G09B 23/00

(52) U.S. Cl. 434/295

(57) ABSTRACT

Provided is a method and apparatus for teaching biology by using a virtual plant or a virtual animal. The method is displayed on a display of a computer and includes collecting growth data of an actual living organism according to different environmental conditions at a predetermined time interval and storing the collected growth data; obtaining a growth equation for each of the environmental conditions based on the growth data; designing a growth animation of the virtual living organism for each of the environmental conditions based on the growth equation; and controlling a control panel screen to fetch the growth data and the growth animation and to display a change in growth of the virtual living organism when a user inputs environmental conditions of the virtual living organism on the control panel screen, to thereby provide high practicality and high educational effects.

### CROSS-REFERENCE TO RELATED PATENT APPLICATION

This application claims the benefit of Korean Patent Application No. 10-2011-0019086, filed on Mar. 3, 2011, in the Korean Intellectual Property Office, the disclosure of which is incorporated herein in its entirety by reference.

### BACKGROUND OF THE INVENTION

1. Field of the Invention

The present invention relates to a method and apparatus for teaching biology by using a virtual living organism, and more particularly, to a method and apparatus for teaching biology by using a virtual living organism such as a virtual plant or a virtual animal.

2. Description of the Related Art

The concept of virtual living organisms, in particular, virtual plants or virtual animals, has been recently developed and is nowadays conventionally used. For example, Korean Patent Application Publication No. 2006-119539 disclosed a method and system for managing an on-line community by using a simulated plant, Korean Patent Application Publication No. 2007-6221 disclosed a method of providing a virtual garden on a computer, Korean Patent Application Publication No. 2000-72751 disclosed a cyber animal farm system, and Korean Patent Application No. 2000-37154 disclosed on-line growth game advertising. According to these related art documents, the educational effects for understanding the characteristics of living organisms may be anticipated to some extent. However, rather than achieving educational purposes to improve understanding the actual living organisms by growing virtual living organisms, entertainment factors that made users have fun by simply growing virtual pets or plants and understanding them were provided.

Instead of such virtual living organisms characterized by entertainment factors, if virtual living organisms, similar to actual living organisms, are provided in the biology classes, the understanding of biology may become easier. For example, the concept of photosynthesis introduced in biology is a complicated one that requires the understanding of a variety of conceptual aspects such as ecology, physiology, biochemistry, and so on. Nevertheless, photosynthesis is one of the difficult subjects for students and is closely relevant to the exploration of the function of living organisms as compared to other biology chapters, and thus, related experiments and practical aspects have been considered to provide important learning opportunities. However, as compared to the importance of exploration activities related to photosynthesis, it is difficult to provide proper learning experiences in school due to many limitations. These limitations are the management of plant growth conditions and the growth period. In particular, in terms of the growth period, even when Rapid-cycling Brassica rapa(RcBr) with a short life cycle is used, at least 14 days are needed until a difference in plant growth according to various environmental conditions is confirmed. In addition, if 5 different light conditions and 5 different temperature conditions were set to perform an experiment under a variety of environmental conditions, 25 experiments in total need to be performed and there are difficulties in maintaining the environmental conditions constant during the growth period. In contrast, a virtual plant could be used to provide a 3D video that shows in a short time, i.e., several minutes, how the plants grow according to light and temperature conditions that are selected by students. Therefore, the issues related to the management of growth conditions and growth period can be resolved. In addition, by providing such a virtual plant on the Web, the students may have an experience similar to observing the growth of an actual plant without any temporal and spatial limitations.

### SUMMARY OF THE INVENTION

The present invention provides a method and apparatus for teaching biology by using a virtual living organism.

The present invention also provides a method and apparatus for teaching biology by using a virtual living organism that is developed as an animation via 3D modeling of an actual living organism, thereby having high practicality and educational effects.

According to an aspect of the present invention, it provides a method of teaching biology by using a virtual living organism that is displayed on a display of a computer, the method including: collecting growth data of an actual living organism according to different environmental conditions at a predetermined time interval and storing the collected growth data in a storage unit; obtaining a growth equation for each of the different environmental conditions based on the growth data and storing the growth equation; designing a growth animation of the virtual living organism for each of the different environmental conditions based on the growth equation and storing the growth animation in the storage unit; and controlling a control panel screen that is displayed on the display to import the growth data and the growth animation that are stored in the storage unit and to display a change in growth of the virtual living organism on the display when a user inputs environmental conditions of the virtual living organism on the control panel screen.

According to another aspect of the present invention, it provides an apparatus for teaching biology by using a virtual living organism that is displayed on a display of a computer, the apparatus including: a storage unit that stores growth data of an actual living organism according to different environmental conditions that are collected at a predetermined time interval, a growth equation for each of the different environmental conditions that is obtained based on the growth data, and a growth animation of the virtual living organism for each of the different environmental conditions that is designed based on the growth equation; and a control unit in the computer that controls a control panel screen that is displayed on the display to import the growth data and the growth animation that are stored in the storage unit and to display a change in the growth on the display when a user inputs environmental conditions of the virtual living organism on the control panel screen.

According to another aspect of the present invention, it provides a computer readable recording medium that stores a software program for executing a method of teaching biology by using a virtual living organism that is displayed on a display of a computer, wherein the method includes: collecting growth data of an actual living organism according to different environmental conditions at a predetermined time interval and storing the collected growth data in a storage unit; obtaining a growth equation for each of the different environmental conditions based on the growth data and storing the growth equation; designing a growth animation of the virtual living organism for each of the different environmental conditions based on the growth equation and storing the growth animation in the storage unit; and controlling a control panel screen that is displayed on the display to import the growth data and the growth animation that are stored in the storage unit and to display a change in the growth of the virtual living organism on the display when a user inputs environmental conditions of the virtual living organism on the control panel screen.

The growth equation may be a regression equation obtained as a sigmoid curve, a growth curve, a quadratic curve, or a cubic curve through nonlinear regression analysis of the growth data by using the environmental conditions as variables.

The control panel screen may include a table-presenting selection window that presents as a table a change in growth according to environmental conditions and time intervals based on the growth data.

The control panel screen may include a graph-presenting selection window that presents as a graph a change in growth according to environmental conditions and time intervals based on the growth data.

The growth data may be stored as a markup language.

The control panel screen may allow a user to input a plurality of environmental conditions of the virtual living organism so that different changes in growth of the virtual living organism under the plurality of environmental conditions are displayed in a plurality of windows.

The display may include a clock that allows a user to recognize a change in growth of the virtual living organism over time.

According to one or more embodiments of the present invention, high educational effects may be obtained using a method and apparatus for teaching biology by using a virtual living organism.

The developed virtual plant has the following merits.

First, students can observe the growth process of a plant through a virtual plant, without any temporal and spatial limitations. Students can easily have the experience of virtually growing a plant via a website at school where the conditions allowing students to raise a living plant by themselves and do research on the plant are restricted.

Second, the virtual plant is applicable to a photosynthesis-related laboratory by using a change in the amount of growth according to light and temperature. Photosynthesis of plants is affected by environmental conditions such as light and temperature, which results in a difference in the growth of plants. Thus, virtual plants are designed to show different growths according to different environmental conditions, thereby being applicable to a photosynthesis-related laboratory.

Third, the virtual plant has been developed through 3D modeling of an actual plant. As a result, a 3D growth video with high practicality is provided to students. Students are susceptible to a visual stimulation provided on the web, and thus, the virtual plant designed as a 3D video, which can stimulate the curiosity of students more than a simple 2D plant image, is useful for a more effective biology lesson.

Fourth, the virtual plant is a student's preferred medium to manipulate on the web and is effective in observing the growth and life of plants.

A virtual animal that is difficult to apply in the case of higher animals but is applicable in the case of lower animals such as protozoa may have the following merits.

First, students can observe the growth process of an animal through a virtual animal in a short time, without any temporal and spatial limitations. Students can easily have an experience of virtually growing an animal via the Web at school where the conditions allowing students to raise an animal by themselves and do research on the animal are restricted.

Second, animals show a growth difference according to several environmental conditions. Virtual animals are designed to show different growths according to different environmental conditions, thereby being applied to the class for understanding the growth and development of animals and environmental impacts thereon.

Third, a virtual animal has been developed through 3D modeling of an actual animal. As a result, a 3D growth video with high practicality can be provided to students. Students are susceptible to visual stimulation provided on the web, and thus, the virtual animal designed via a 3D video, which can stimulate the curiosity of students more than a simple 2D animal image, is useful for a more effective biology lesson.

Fourth, a virtual animal is one of the student's preferred media to manipulate on the web and is effective in having an experience of observing the growth and life of animals.

As described above, in view of the characteristics of biology, web-based media used in developing a web-based biology teaching and learning program have been developed for understanding the life of living organisms, and a degree of reflecting the actual life is closely related to the learning effects. Thus, virtual living organisms developed by mainly focusing on the life thereof may further enhance the educational effects of web-based biology teaching and learning programs.

### BRIEF DESCRIPTION OF THE DRAWINGS

The above and other features and advantages of the present invention will become more apparent by describing in detail exemplary embodiments thereof with reference to the attached drawings in which:

FIG. 1 is a screenshot for explaining a method of teaching biology by using a virtual plant, the screen shot showing the growth of the virtual plant according to environmental conditions, according to an embodiment of the present invention;

FIG. 2 illustrates screenshots showing cases where buttons of growth data and growth graph on the user's data input menu illustrated in FIG. 1 are each clicked, according to an embodiment of the present invention;

FIG. 3 is a flowchart for explaining a method of teaching biology by using a virtual plant, according to an embodiment of the present invention;

FIG. 4 is a diagram for explaining concepts of environmental conditions and growth of a virtual plant, according to an embodiment of the present invention;

FIG. 5 illustrates graphs showing growth curves obtained by regression analysis of growth data of an actual plant in order to prepare a virtual plant, according to an embodiment of the present invention;

FIG. 6 illustrates images for explaining a process of collecting modeling data for preparing a virtual plant, according to an embodiment of the present invention;

FIGS. 7 and 7A to 7G are for explaining a 3D modeling process of a virtual plant by using Blender 2.0 in order to prepare a virtual plant, according to an embodiment of the present invention;

FIG. 8 illustrates screenshots of captured live images of a plant growing at 8000 lux at 20° C. in order to prepare a virtual plant, according to an embodiment of the present invention;

FIG. 9 illustrates screenshots for explaining a method of creating a virtual plant growth animation by analyzing the live images of FIG. 8, according to an embodiment of the present invention;

FIG. 10A is a block diagram for explaining an apparatus for teaching biology by using a virtual living organism, according to an embodiment of the present invention; and

FIG. 10B is a block diagram for explaining an apparatus for teaching biology by using a virtual living organism, according to another embodiment of the present invention.

### DETAILED DESCRIPTION OF THE INVENTION

Hereinafter, exemplary embodiments of the present invention will be described in detail with reference to the accompanying drawings.

According to exemplary embodiments of the present invention, there are provided a method and apparatus for teaching biology by using a virtual living organism. In this regard, for convenience of explanation, plants with a relatively short life cycle are exemplified.

Although only a plant is illustrated in the drawings for convenience of understanding, it is obvious to one of ordinary skill in the art that growth data of an animal according to variables such as environmental conditions, for example, breed, genetic information, soil, climate, nutrient, and population may be measured at a predetermined time interval, a growth equation may be obtained using the growth data, for example, by nonlinear regression analysis, and the growth equation may be then displayed as an animation.

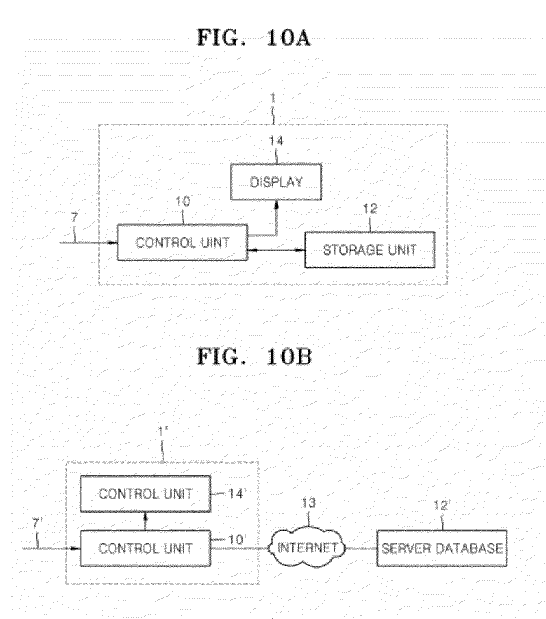

FIGS. 10A and 10B respectively illustrate structures of apparatuses 1 and 1′ for teaching biology by using a virtual living organism. In FIGS. 10A and 10B, an input unit such as a mouse or a keyboard is not illustrated and a detailed description thereof is not provided herein.

Referring to FIG. 10A, the apparatus 1 for teaching biology by using a virtual living organism may be a general computer such as a desktop computer, a notebook computer, a netbook, or a computing terminal, and includes a control unit 10, a storage unit 12, and a display 14.

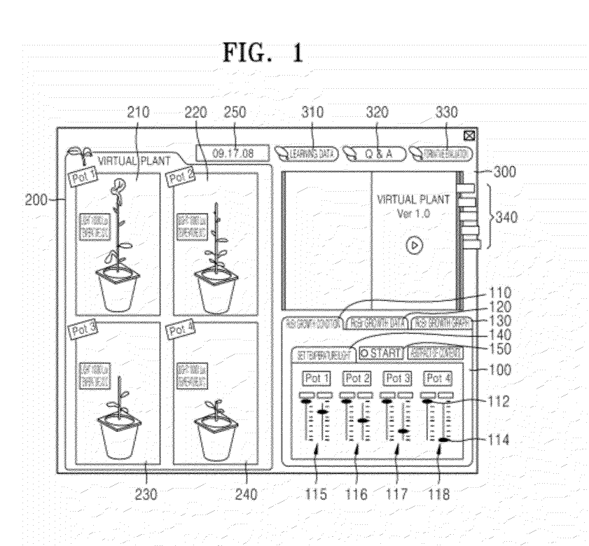

With regard to FIG. 10A, to design a virtual living organism, a designer collects growth data of an actual living organism according to environmental conditions at a predetermined time interval, obtains a growth equation for each environmental condition based on the growth data, produces a virtual living organism growth animation for each environmental condition based on the growth equation, and stores the virtual living organism growth animation in the storage unit 12. The storage unit 12 also stores a statistical program such as a statistical package for social sciences (SPSS) needed for the regression analysis of growth data. When a user inputs environmental conditions of a virtual living organism on a control panel screen (refer to 100 of FIG. 1) that is displayed on the display 14, the control unit 10 fetches the growth data and the growth animation that are stored in the storage unit 12 and controls the display 14 to display a change in growth of the virtual living organism. In FIG. 10A, reference numeral 7 denotes data that are input to the apparatus 1, such as growth data, environmental conditions, and program execution commands.

With regard to FIG. 10B, to design a virtual living organism, a designer collects growth data of an actual living organism according to environmental conditions at a predetermined time interval, obtains a growth equation for each environmental condition based on the growth data, produces a virtual living organism growth animation for each environmental condition based on the growth equation, and stores the virtual living organism growth animation in a server database 12′ that is positioned outside the apparatus 1′. The server database 12′ also stores a statistical program such as SPSS needed for the regression analysis of growth data. When a user inputs environmental conditions of a virtual living organism on a control panel screen (refer to 100 of FIG. 1) that is displayed on a display 14′, a control unit 10′ fetches the growth data and the growth animation that are stored in the server database 12′ and controls the display 14′ to display a change in growth of the virtual living organism. In FIG. 10B, reference numeral 7′ denotes data that are input to the apparatus 1′, such as growth data, environmental conditions, and program execution commands.

The structure and operation of the apparatus 1′ of FIG. 10B are the same as those of the apparatus 1 of FIG. 10A, except that the apparatus 1′ uses as a storage unit, that is, the server database 12′, which is accessed by the apparatus 1′ via an Internet network 13 and is connected to a server (not shown) that is externally positioned, instead of using a storage unit like the storage unit 12 of the apparatus 1.

Hereinafter, structures and operations of a method and apparatus for teaching biology by using a virtual plant according to exemplary embodiments of the present invention will be described in more detail with reference to the accompanying drawings.

Development of a Virtual Plant for Teaching and Learning the Photosynthesis

A virtual plant has been developed to provide students with an experience of effectively learning a change in photosynthesis and growth of a plant according to environmental conditions through Web-based biology teaching and learning. The virtual plant is obtained by designing a growth pattern of an actual plant under constant light and temperature conditions as a 3D animation and time-based growth data are provided to students, whereby the virtual plant may be used in research on a variety of plants.

Structure of the Virtual Plant

FIG. 1 is a screenshot for explaining a method of teaching biology by using a virtual plant, the screenshot showing a growth of the virtual plant according to environmental conditions, according to an embodiment of the present invention. Referring to FIG. 1, the display 14 or 14′ (refer to FIGS. 10A and 10B) of the apparatus 1 or 1′ (refer to FIGS. 10A and 10B) includes a control panel window 100, a virtual plant window 200 illustrating pots for showing the growth of the virtual plant, and a window 300 for introducing virtual inquiry activity.

The control panel window 100 includes a plant growth condition button 110, a plant growth data button 120, a plant growth graph button 130, a temperature/light (illuminance) (growth conditions of a plant) set selection button 140, a temperature set button 112, an illuminance set button 114, pots 115 through 118 of the virtual plant, and a start button 150.

The virtual plant window 200 includes pots 210 through 240 in which the virtual plant is planted and a clock 250 showing the elapsed time.

The window 300 includes a learning data button 310 for conducting research activity through the virtual plant, a Q&A button 320, a formative evaluation button 330, and a plurality of buttons 340 for introducing the kind of plant, an environmental factor of the plant, the growth of the plant, and the like.

FIG. 1 illustrates an activity of virtually growing a plant in at most four pots such that students can adjust the growth conditions of the plant by selecting two of the environmental conditions (i.e., temperature and light), by clicking the growth condition button 110 of the control panel window 100 and by adjusting the temperature set button 112 and the illuminance set button 114 for each of the pots 115 through 118 when the temperature/light set selection button 140 is activated.

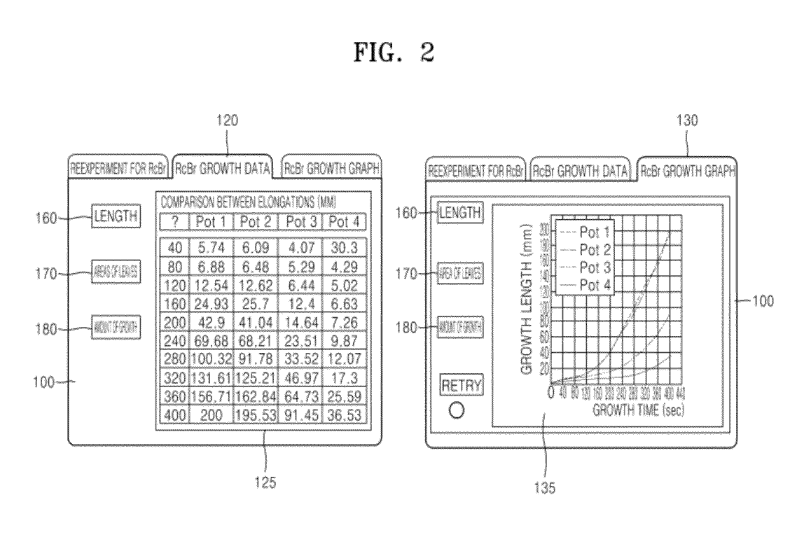

FIG. 2 illustrates screenshots showing cases where a growth data button and a growth graph button on the user's data input menu illustrated in FIG. 1 are each clicked, according to an embodiment of the present invention.

As illustrated in FIG. 2, students may confirm and compare growth data 125 and a graph 135 of virtual plants which they grow by activating the growth data button 120 and the growth graph button 130 of the control panel window 100. In addition, several growth data and graphs may be confirmed and compared by activating a length button 160, a leaf area button 170, and a growth amount button 180 on the screen illustrating the growth data 125 and the graph 135 of the virtual plants.

In the virtual plant window 200, it takes about 50 seconds to create a growth process of the virtual plant as an animation. In the control panel window 100, students may simultaneously confirm and compare the growth data 125 and the graph 135 of the virtual plants which they grow in a short time. Students confirm a difference in growth of plants under various environmental conditions through three-dimensional (3D) animation on the virtual plant window 200, and through the growth data 125 and the graph 135 on the control panel window 100 and learn photosynthesis-related contents. The overall processes are performed such that students can observe the growth of plants under various conditions through plant growth simulation and then understand a relationship between the growth of plants and temperature and light that affect photosynthesis. In addition, although not illustrated in the drawings, a process for understanding the relationship between photosynthesis and the concentration of CO₂ may be performed.

Development Process of the Virtual Plant

Basic Concept and Development Goal of the Virtual Plant

A virtual plant is a program allowing users to manipulate the temperature and light conditions that affect the growth of plants and confirm a difference in the growth of plants according to these conditions. In addition, a growth pattern that is formalized from an appearance similar to an actual plant and growth data of the actual plant is created as a 3D animation so that students can have a real observation experience through the 3D animation. The development goal of the virtual plant is as follows.

First, a growth animation is developed such that the type of growth of an actual plant and growth-related data (e.g., length, the areas of leaves, biomass) are collected and used and 3D modeling of each of a plurality of sites of the plant is performed. Then, the growth animation is provided as a plant growth 3D animation through the Web, from which students can have an experience similar to growing an actual plant.

Second, the virtual plant program is designed to allow users to set the light and temperature conditions and to repeatedly perform an experiment a desired number of times. Therefore, an opportunity of finding a relationship between concepts (the relationship between the growth of plants and temperature and light conditions) from the regularity of phenomena occurring as a result of the settings and the experiments is provided.

Detailed Development Process of the Virtual Plant

Concept Design of the Virtual Plant

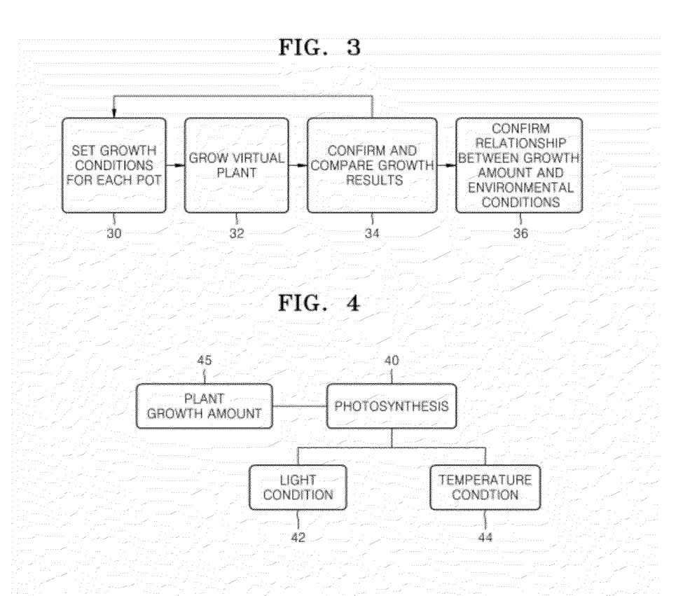

FIG. 3 is a flowchart for explaining a method of teaching biology by using a virtual plant, according to an embodiment of the present invention. As illustrated in FIG. 3, a virtual plant is a program showing results of growing a virtual plant (operation 32) by setting growth conditions for each pot by a user (operation 30) as a 3D animation. The overall processes are performed such that, based on an inductive research model that finds out regularity from various cases, students can visually confirm a difference in growth of plants through comparison of the 3D animation (operation 34). In addition, growth conditions of the virtual plant are set similar to those of an actual plant and thus an experience similar to observing an actual plant may be provided (operation 36).

Virtual Plant-Related Learning Contents

Contents related to environmental conditions that affect photosynthesis as virtual plant-related learning contents are presented as a research activity on the relationship between photosynthesis 40 and environmental conditions as illustrated in FIG. 4. This research activity is described in ‘Nutrients of Plants’ of the 7th grade science in Korea. The virtual plant program embodies growth data including amount of plant growth 45 such as the lengths of stems, the number of leaves, and biomass from a difference in photosynthesis by light conditions 42 and temperature conditions 44, which are environmental factors that affect the plant growth (refer to FIG. 4), and such a process helps students understand the concepts of photosynthesis and environmental conditions.

Design of the Virtual Plant

Select the Standard Plant for the Development of the Virtual Plant

A virtual plant needs to have the characteristics of an actual plant, and thus, a standard plant that provides actual data of biological characteristics such as appearance and a growth pattern is needed. As the standard plant, a plant that follows the general type of plants and is easy for modeling needs to be selected. In addition, to embody a growth pattern of the virtual plant, the standard plant needs to be capable of growing even under restricted conditions and the amount of growth of the standard plant needs to be easily measured. As the standard plant that satisfies the conditions described above, Rapid-cycling Brassica rapa(RcBr) is selected.

RcBr has unique characteristics of a plant, is easy to be manipulated, and is of a simple type. Thus, in foreign countries including United States, RcBr has received much attention as a very effective plant material for use in various experiments in science or biology classes ranging from primary schools to universities. In Korea, research on a method of using RcBr in biology class in elementary and middle school classes has been conducted since the early 2000s. In addition, RcBr has a short life cycle, and thus, growth data may be obtained in a short time from a plurality of individuals. For this research, a standard type of RcBr is selected as an individual wherefrom growth-related data can be easily collected. The life cycle of RcBr is 40 to 45 days, RcBr flowers appear about 14 days after RcBr seeds are sown, and an average height of RcBr is about 15 cm after 14 days.

Method of Collecting Growth Data of the Virtual Plant

Growth data of RcBr selected as a standard plant were collected at a certain interval (i.e., date-based) while RcBr plants were grown under particular environmental conditions at least 20 days after being sown, and the collected growth data were stored in an Excel file and analyzed.

Measurement of Stem Length

Data related to stem growth of RcBr may be obtained by quantitatively measuring stem elongation. Also, by measuring each internode, a total length of the stem and aspects of its elongation could be determined. The stem elongation of RcBr was measured with respect to the length between nodes, which is easy to be measured, and the length of hypocotyl and the lengths between nodes were measured and recorded.

Measurement of Leaf Size

Leaves of RcBr may be divided into cotyledons and leaves. The cotyledons are positioned at the first stem node and one of them is on the left side and the other one is on the right side. One of the two cotyledons was selected, a pot including the selected cotyledon was marked, and the size of the cotyledon was then measured. One or two of the leaves were positioned at each node and RcBr generally has 3 to 4 leaves. To measure the size of each leaf, the lengths of a leafstalk and a leaf were measured and a vertical width of the leaf was further measured for accurate measurement of the leaf area. The length of the leaf was measured from a position where leaf blades started to grow, while the length of a leaf not including blades was measured from a position where the leaf blades started to grow. On the other hand, in a case of leaves developed without having a leafstalk according to morphological variation of leaves, measurement of the length of the leafstalk was omitted.

Collecting the Flowering Data

RcBr starts to bloom from about 12 days after being sown and forms flowers about 14 days after RcBr seeds are sown. The flowers of RcBr are mainly formed on a stem apex and also on the side below the stem apex. The length of a flower stalk of each flower was measured, the number of the flowers was counted, and these values were collected as data.

Measurement of Biomass

The biomass of RcBr was collected by measuring the mass of RcBr. 60 RcBr plants were grown for 17 days under predetermined environmental conditions, 10 individuals were harvested at an interval of three days each for five times, and the masses of the RcBr plants were measured.

Setting Environmental Conditions

To measure the growth data described above, at least 30 RcBr plants were sown and grown for 17 days or longer under constant environmental conditions and growth data were collected three times per week. In this regard, the temperature conditions ranged from no less than 10° C. to no more than 30° C. at an interval of 5° C., and the intensity of light was fixed at 8,000 lux. Also, light was set to range from no less than 2,000 lux to no more than 10,000 lux at an interval of 2,000 lux, and temperature was fixed at 20° C. Sick or withered individuals during cultivation were excluded and growth equation was calculated by regression analysis using a software program for statistical analysis, which is a statistical package for social sciences (SPSS), by using the measured data.

Obtaining Growth Equation by Using Growth Data

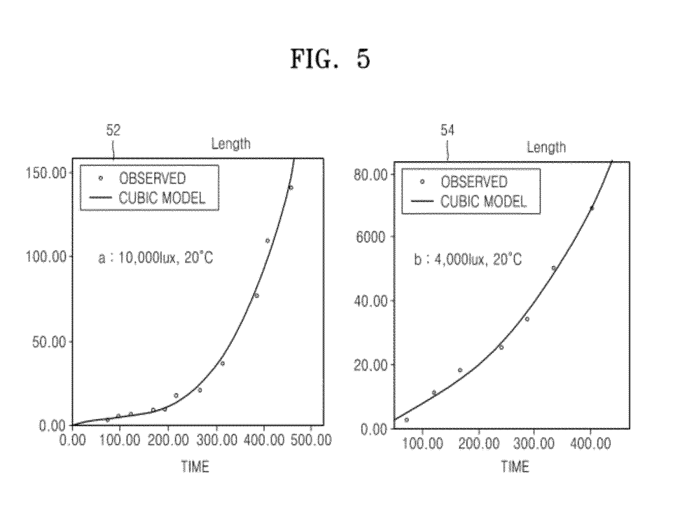

A growth pattern according to environmental conditions of the virtual plant was designed to be similar to that of an actual plant in order to provide students with a real observation experience. For this, stems and leaves of RcBr plants that were actually grown under certain temperature and light conditions were periodically measured to obtain growth data, a growth equation for each environmental condition was obtained using nonlinear regression analysis based on the growth data, growth equations for various conditions were induced therefrom, and a growth animation for each condition was designed based thereon. The growth equation for each growth condition was obtained by calculating average lengths of RcBr at different time points and performing regression analysis thereon. FIG. 5 illustrates a growth curve 52 obtained under conditions of an illuminance of 10,000 lux and a temperature of 20° C. and a growth curve 54 obtained under conditions of an illuminance of 4,000 lux and a temperature of 20° C.

Time-based growth data under certain light and temperature conditions were obtained as growth curves by regression analysis of the SPSS program and growth data that were estimated up to 400 hours at an interval of 40 hours were calculated. Similarly, elongation data that were estimated up to 400 hours after RcBr plants were sown under 9 environmental conditions at an interval of 40 hours were calculated. In addition, stem elongation values for 25 environmental conditions composed of 5 light conditions and 5 temperature conditions were calculated using a growth equation for a certain time period. Similarly, estimated elongation values were obtained up to at most 400 hours at an interval of 40 hours.

The growth equation was obtained using a total length, the leaf areas, and biomass, and the length of internodes and the leaf size were used to design a growth animation. In order to present the growth equation, revised average values were obtained from the data except for the defective ones that were measured for each time point under specific light and temperature conditions as shown in Table 1.

TABLE 1
Length of hypocotyls, internodes, and total length of individuals

| Indi- | | node | node | node | node | node | Total |
|---|---|---|---|---|---|---|---|
| vidual | hypocotyl | 1 | 2 | 3 | 4 | 5 | length |
| 1 | 21.85 | 14.79 | 23.02 | 19.61 | 15.34 | | 94.61 |
| 2 | 17.67 | 12.91 | 11.53 | 4.29 | 4.42 | | 50.82 |
| 3 | 16.83 | 17.93 | 12.55 | 18.95 | 11.35 | | 77.61 |
| 4 | 18.32 | 35.22 | 18.06 | 15.72 | 17.81 | | 105.13 |
| 5 | 15.82 | 19.48 | 43.60 | 4.37 | 4.74 | | 88.01 |
| 7 | 17.07 | 14.68 | 5.11 | 9.92 | 9.66 | | 56.44 |
| 9 | 17.65 | 12.80 | 2.91 | 26.15 | 2.69 | | 62.20 |
| 12 | 22.92 | 23.92 | 17.48 | 26.32 | 20.95 | 11.76 | 123.35 |
| 13 | 20.04 | 12.07 | 11.41 | 33.48 | 43.50 | | 120.50 |

RcBr seeds were placed in water and germinated in a dark room at 20° C. for 24 hours, and the RcBr seeds were then put in a growth chamber where the temperature and light were maintained constant and grown for 17 days or longer, thereby measuring growth data. In the growth chamber maintained at a constant temperature of 20° C., 5 light conditions were set, and when light was set constantly at 8,000 lux, 5 temperature conditions were set. As a result, growth data of RcBr plants under 9 different growth conditions as shown in Table 1 were obtained. The lengths of stems was measured as a length between nodes, the lengths of leaves were measured from a portion on which the leaves started to grow, and the width of leaves was measured with respect to the widest position. The measurement was performed using a Digimatic caliper. The measurement was performed at an interval of 2 to 3 days and the growth data of the RcBr seeds grown for 17 days or longer were obtained using at least 30 individuals of RcBr per one growth condition.

The total 9 growth equations were confirmed and the growth lengths were then calculated up to at most 400 hours at an interval 40 hours. Through nonlinear regression analysis with respect to temperature and light conditions by using the growth length for a certain time period, time-based growth lengths under non-measured 16 growth conditions were calculated (refer to Table 2).

In addition, 10 growth equations for a total of 25 condition combinations that were extended from the conditions shown in Table 2 below were induced for at most 400 hours at an interval of 40 hours. Stem elongation data under each environmental condition were calculated and a 3D animation and data of the virtual plant were applied to data represented in tables and graphs.

TABLE 2
Change in growth according to different temperature
conditions under constant light condition

| Light | Temperature | Time after seeding (hr) | | | | | |
|---|---|---|---|---|---|---|---|
| (lux) | (° C.) | 40 | 120 | 200 | 280 | 360 | 400 |
| 10,000 | 10 | 1.94 | 2.86 | 4.71 | 5.22 | 6.17 | 12.83 |
| | 15 | 2.91 | 6.06 | 7.61 | 13.70 | 31.85 | 51.47 |
| | 20 | 3.88 | 8.83 | 15.42 | 33.67 | 72.37 | 103.07 |
| | 25 | 4.85 | 11.06 | 27.61 | 62.39 | 118.42 | 156.34 |
| | 30 | 5.82 | 12.85 | 42.56 | 95.82 | 164.44 | 206.40 |

9 sets of elongation data for each time period were used in nonlinear regression analysis using SPSS and the nonlinear regression analysis was performed using light and temperature as variables. As an equation needed in the nonlinear regression analysis, the most similar pattern from among a sigmoid curve, a growth curve, a quadratic curve, and a cubic curve was selected and a regression equation satisfying R²≧0.70 was selected as a growth equation.

For example, a restricted nonlinear regression analysis program is represented as follows. In this case, parameter estimates and analysis of variance of the data set are shown in Tables 3 and 4 below.

*Nonlinear regression
MODEL PROGRAM b0=0 b1=0 b2=0 b3=0 b4=0 b5=0.
COMPUTE PRED_=(((EXP(b0+b1/LIGHT))*EXP(b2+b3/THERM))))*b4.
CNLR length

/OUTFILE-‘C:\DOCUME-1\Programmer:Eunkyung\LOCALS-1\Temp\sp

ss2032\SPSSFNLR.TMP’

/PRED PRED_{—}
/BOUNDS b0 <− −2: b1 <− −1
/CRITERIA STEPLIMIT 2 ISTEP 1E+2D.

→[Data set 1] G: \RCER\regression analysis\CNWJDWWKFY\400

minutes.sav

TABLE 3
Estimation of growth equation by nonlinear regression analysis

| | | | 95% confidence interval | |
|---|---|---|---|---|
| Parameter | Estimate | Standard error | Lower limit | Upper limit |
| b0 | −2.053 | 4.956E7 | −2.132E8 | 2.132E8 |
| b1 | −1.000 | 1517.083 | −6528.482 | 6526.482 |
| b2 | 1.661 | 7.515E7 | −3.233E9 | 3.233E8 |
| b3 | −22.546 | 13.694 | −81.466 | 38.374 |
| b4 | 40.335 | 1.666E9 | −7.169E9 | 7.169E9 |
| b5 | 0.000 | 0.000 | 0.000 | 0.000 |

TABLE 4
Results of variance by nonlinear regression analysis

| | | Degrees of | |
|---|---|---|---|
| Source | Sum of squares | freedom | VUDRS² |
| Regression model | 643.888 | 6 | 102.315 |
| Residual | 23.375 | 2 | 11.667 |
| Unadjusted sum | 667.263 | 8 | |
| Adjusted sum | 88.412 | 7 | |

The elongation data of RcBr for each environmental condition, which were obtained by the growth equation, were applied to design a 3D video of a virtual plant and provided as growth data to students. In terms of the leaf areas and biomass, growth equations for a total of 25 environmental conditions were obtained using the same method as used to obtain the growth equations for the stem lengths and were applied to a virtual plant animation and growth data, respectively. Time-based data of the lengths, the leaf areas and biomass for each environmental condition were designed as an XML (markup language) file. In this regard, the growth data were loaded according to environmental conditions chosen by students so that they were used to select a growth animation and present time-based growth data as tables and graphs.

Modeling of the Virtual Plant Using RcBr and Design Panel for Selecting the Environmental Conditions

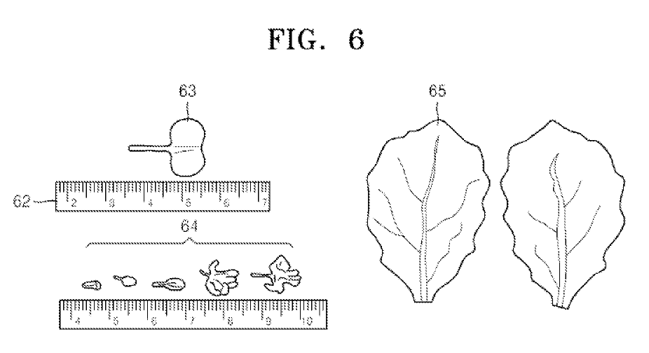

FIG. 6 illustrates images for explaining a process of collecting modeling data for a virtual plant, according to an embodiment of the present invention. To express the life of an actual plant by using a virtual plant, time-based characteristics of growth processes of RcBr used as a model and a detailed design are needed. To achieve these conditions, as illustrated in FIG. 6, growth of actual RcBr was photographed by a digital camera and a time-based analysis was then performed, and morphological change patterns 63 through 65 of stems and leaves were confirmed using a graduated ruler 62 and the measured data were used to design a growth animation.

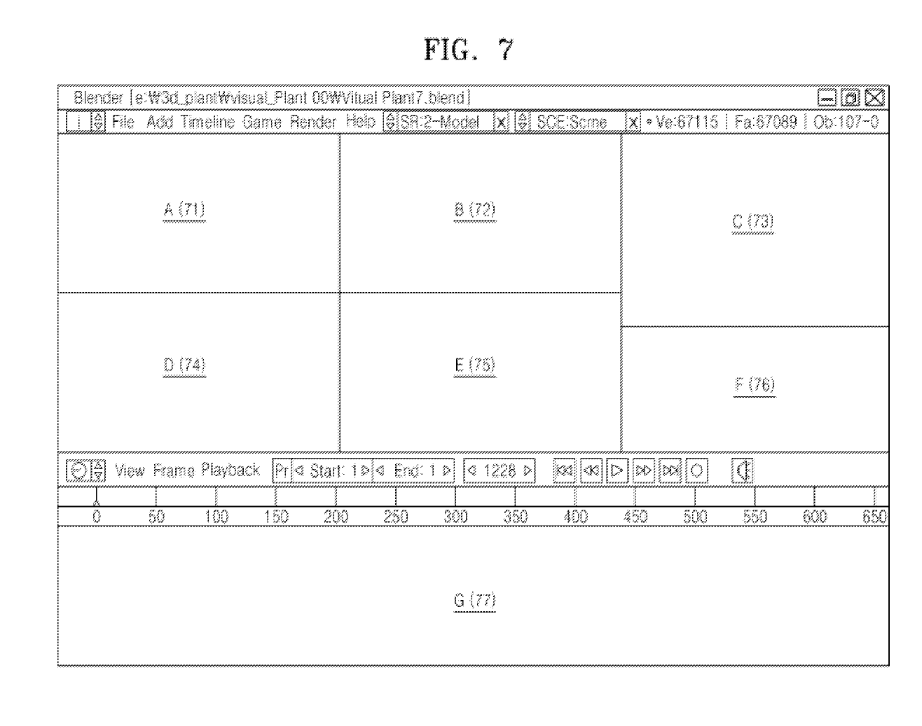

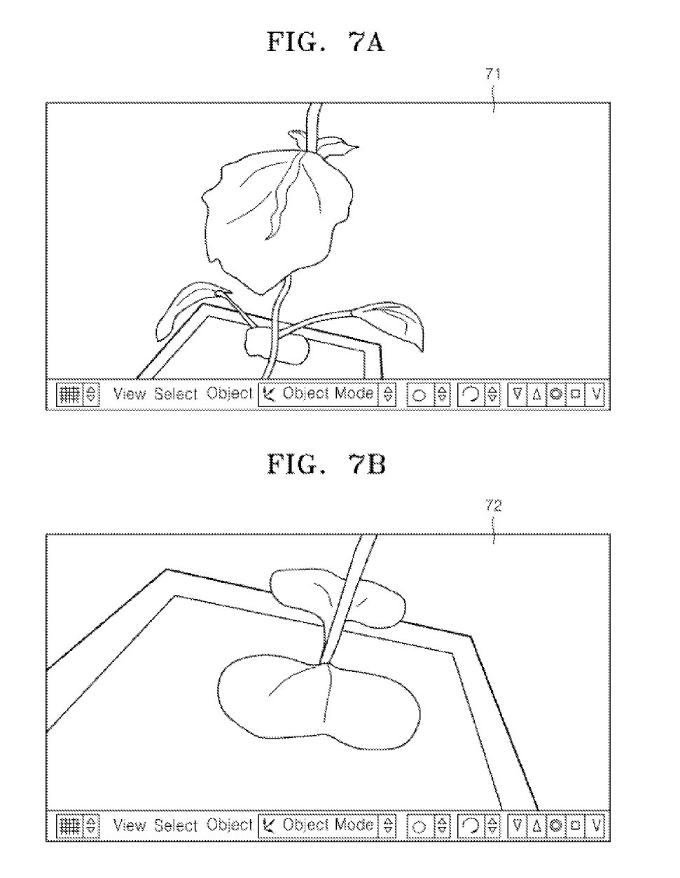

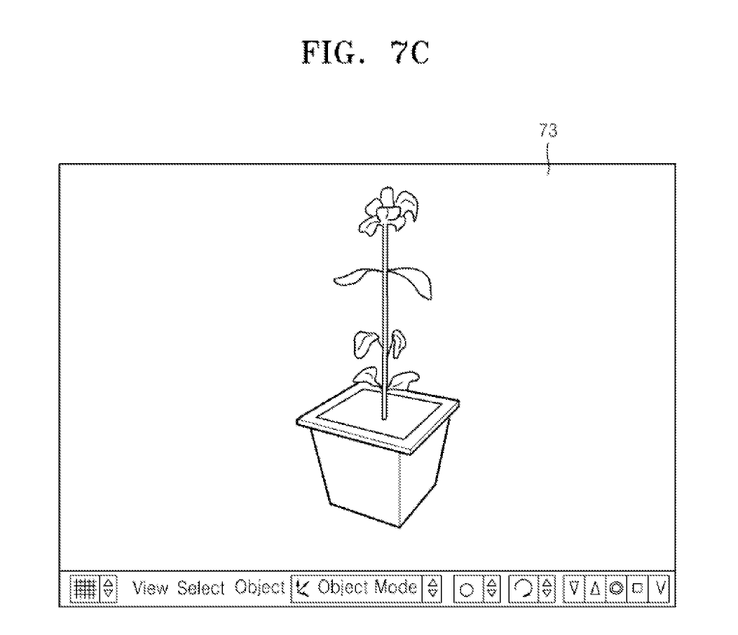

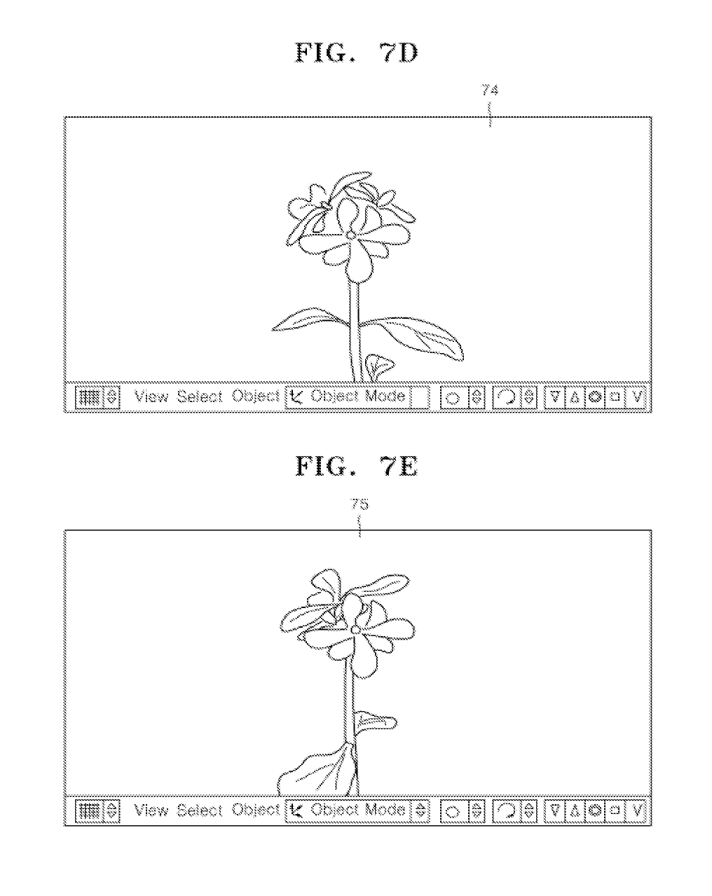

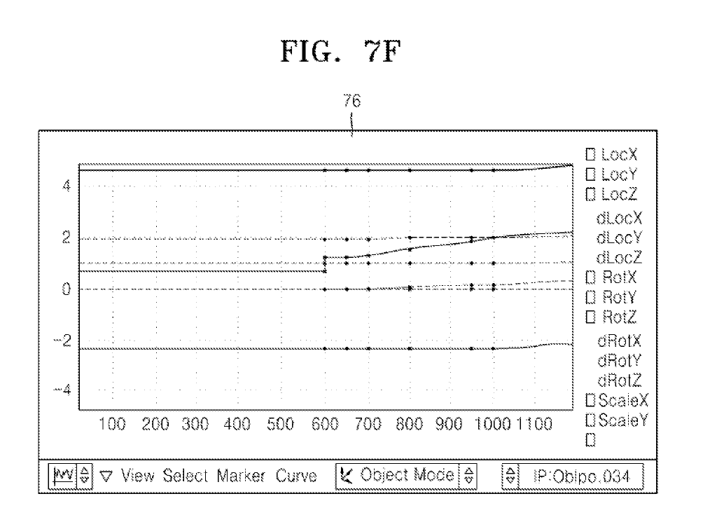

FIGS. 7 and 7A to 7G are for explaining a 3D modeling process of a virtual plant by Blender 2.0 to prepare a virtual plant, according to an embodiment of the present invention. As illustrated in FIGS. 7 and 7A to 7G, images obtained by a digital camera were applied to a 3D individual animation design needed for designing a virtual plant, stems and leaves of RcBr were designed as 3D individuals 71 through 75 by using a 3D design program tool screen 77, and the designed 3D individuals 71 through 75 were represented by a graph 76.

In the virtual plant, a control panel window (screen window) (refer to 100 of FIG. 1) for selecting growth conditions by students is a region for adjusting growth conditions of the virtual plant, and 5 different temperature conditions and 5 different light conditions may be chosen by students independently for 4 pots. Adjustable temperature conditions ranged from no less than 10° C. to no more than 30° C. and illuminance was set in a range from no less than 2,000 lux to no more than 10,000 lux.

Producing Growth Animation of the Virtual Plant

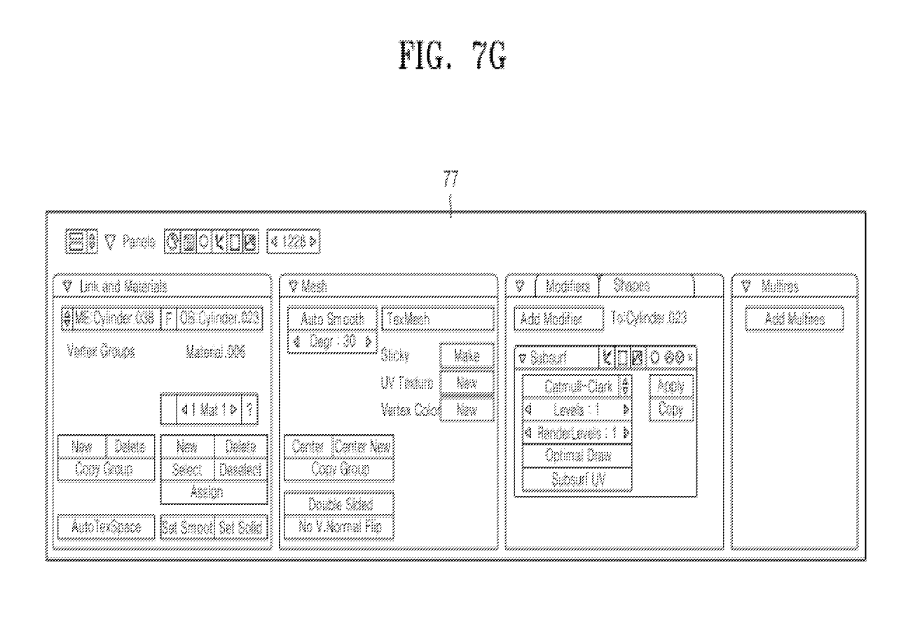

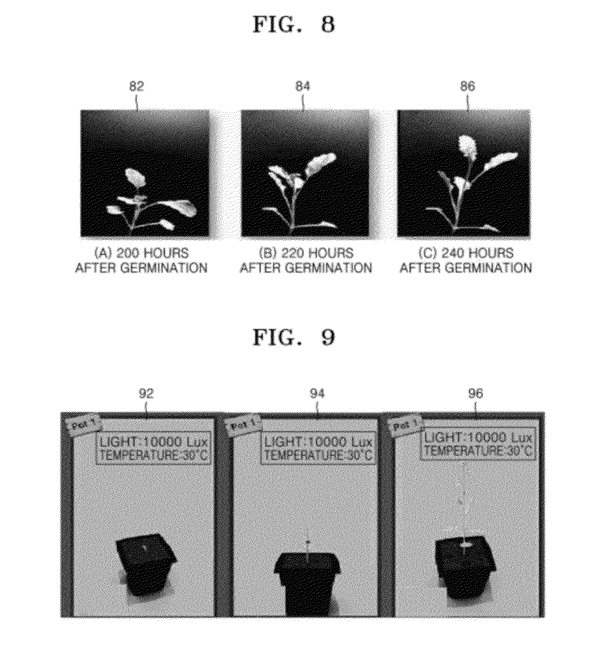

FIG. 8 illustrates screenshots of capturing live images of RcBr growing at 8000 lux at 20° C. to prepare a virtual plant, according to an embodiment of the present invention. To design growth of the virtual plant as a 3D video, a growth video of actual RcBr showing a growth pattern and growth data measured under particular conditions for at least 17 days were used. Growth live images of RcBr as illustrated in FIG. 8 were obtained such that RcBr that was being grown in a growth chamber was photographed by an interval shutter of a digital camera and the photographed images were designed as live images 82, 84, and 86. In FIG. 8, the live image 82 denotes RcBr 200 hours after germination, the live image 84 denotes RcBr 220 hours after germination, and the live image 86 denotes RcBr 240 hours after germination.

FIG. 9 illustrates screenshots for explaining a method of creating a virtual plant growth animation by analyzing the live images of FIG. 8, according to an embodiment of the present invention. Stem elongation, leaf development, and a growth pattern were determined by analyzing video images, and a change in the sites of stem elongation and its order were used to design a 3D video animation. A growth animation of the virtual plant for each environmental condition was embodied as a growth equation such that regression analysis was performed on a time-based change in the lengths of stems and the areas of leaves of RcBr grown under 25 environmental conditions obtained by combination between 5 light conditions and 5 temperature conditions. A difference in growth of RcBr for each environmental condition was obtained by the growth equation with respect to the lengths of stems and the areas of leaves and applied to design 25 growth animations for condition combinations of five different light conditions and five different temperature conditions. In FIG. 9, an animation 92 denotes RcBr 156 hours after germination, an animation 94 denotes RcBr 269 hours after germination, and an animation 96 denotes RcBr 351 hours after germination.

Time-based growth of the virtual plant under each environmental condition was determined based on the data obtained by a growth equation and growth animations of the virtual plant were designed using growth patterns of live images. Leaves of the virtual plant were designed using the lengths of leaves and leafstalks under each environmental condition and a relative difference in the total leaf areas was obtained using a growth equation with respect to the leaf areas.

Design of the Virtual Plant Using Actionscript

To design a virtual plant as a functional unit by integrating constituents of the virtual plant, the virtual plant was designed based on Flash CS4. Tables and graphs for presenting data were integrated based on a growth animation and a control panel of the virtual plant, thereby completing the design of the virtual plant. To associate results of selecting growth environmental conditions of the virtual plant by students with growth animations and growth data, an actionscript provided by a Flash CS4 program was used.

The actionscript selects and loads each of a plurality of virtual plant animation files by using environmental conditions that are selected on a control panel by students as input variables of each of a plurality of pots. In addition, the input variable stores as an outcome variable the lengths of stems, the areas of leaves, and biomass of each pot that are selected from growth data loaded from an XML file and the outcome variable is then used to create tables and graphs of growth data. The tables present as data a change in the lengths of leaves, the areas of leaves, and biomass at an interval of 40 hours for the total growth time of 400 hours, and the graphs represent growth data of the virtual plant of each pot that are presented in the tables as a time-based change.

The virtual plant that is developed using Flash CS4 consists of a 3D animation region that shows a difference in growth of the virtual plant according to environmental conditions, a region for selecting growth environmental conditions and confirming the results, and a learning-related region. The region for selecting growth environmental conditions and confirming the results consists of sub-regions: RcBr growth condition selection, RcBr Growth DATA, and RcBr Growth Graph (refer to FIG. 1).

The RcBr growth condition selection allows students to select light and temperature conditions for 4 pots from 5 light conditions and 5 temperature conditions and one of the 25 growth conditions is selected by students (from 1 to 25). When a start button is clicked, a 3D animation is selected according to the value given to each pot and played on a window for each pot, and an upper clock is simultaneously operated to show growth for 17 days. The values given to each pot are applied in a process of loading necessary data of RcBr Growth DATA and RcBr Growth Graph, and data corresponding to the given values from the previously stored growth data are loaded and stored as variables and then presented as tables and graphs. In this regard, after loading data, in order to provide variability, a random function was applied and it was designed that even different data values could be obtained under the same conditions every time.

Application of the Virtual Plant to Web-Based Teaching and Learning

To apply a developed virtual plant to a web-based teaching/learning program so that the virtual plant is available on the Web, contents needed for a teaching/learning process are added. For a photosynthesis class, the ‘abstract of the concept of photosynthesis, formative evaluation, additional learning data’ are developed as a Flash movie and a growth animation of the virtual plant is integrated with a control panel, tables, and graphs, thereby embodying the virtual plant as a Web-based teaching/learning program for the photosynthesis class (refer to FIG. 1). For this, the prevent invention provides a computer readable recording medium that stores a software program for executing a method of teaching biology by using a virtual plant that is displayed on a display of a computer.

As described above, according to the one or more embodiments of the present invention, a virtual plant is provided. Also, similarly, in the case of virtual animals such as lower animals, for example, amebas and paramecia, and higher animals, for example, vertebrates, growth data of an actual plant and growth curves of the actual plant according to environmental conditions such as climate, soil, temperature, light, moisture, and nutrients may be set, and by varying environmental conditions, a virtual animal may be designed by using the data stored in a database and a computer program. By using the virtual animal, biology may be taught in a short time without any temporal and spatial limitations.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of teaching biology by using a virtual living organism that is displayed on a display of a computer, the method comprising:
collecting growth data of an actual living organism according to different environmental conditions at a predetermined time interval and storing the collected growth data in a storage unit;
obtaining a growth equation for each of the different environmental conditions based on the growth data and storing the growth equation;
designing a growth animation of the virtual living organism for each of the different environmental conditions based on the growth equation and storing the growth animation in the storage unit; and
controlling a control panel screen that is displayed on the display to fetch the growth data and the growth animation that are stored in the storage unit and to display a change in growth of the virtual living organism on the display when a user inputs environmental conditions of the virtual living organism on the control panel screen.

2. The method of claim 1, wherein the growth equation is a regression equation obtained as a sigmoid curve, a growth curve, a quadratic curve, or a cubic curve through nonlinear regression analysis of the growth data by using the environmental conditions as variables.

3. The method of claim 1, wherein the control panel screen comprises a table-presenting selection window that presents as a table a change in growth according to environmental conditions and time intervals based on the growth data.

4. The method of claim 1, wherein the control panel screen comprises a graph-presenting selection window that presents as a graph a change in growth according to environmental conditions and time intervals based on the growth data.

5. The method of claim 1, wherein the control panel screen allows a user to input multiple environmental conditions of the virtual living organism so that different changes in the growth of the virtual living organism under multiple environmental conditions are displayed on multiple windows.

6. The method of claim 1, wherein the display comprises a clock that allows a user to recognize a change in growth of the virtual living organism over time.

7. An apparatus for teaching biology by using a virtual living organism that is displayed on a display of a computer, the apparatus comprising:
a storage unit that stores growth data of an actual living organism that is collected at a predetermined time interval according to different environmental conditions, a growth equation for each of the different environmental conditions that is obtained based on the growth data, and a growth animation of the virtual living organism for each of the different environmental conditions that is designed based on the growth equation; and
a control unit in the computer that controls a control panel screen that is displayed on the display to fetch the growth data and the growth animation that are stored in the storage unit and to display a change in growth of the virtual living organism on the display when a user inputs environmental conditions of the virtual living organism on the control panel screen.

8. The apparatus of claim 7, wherein the growth equation is a regression equation that is obtained as a sigmoid curve, a growth curve, a quadratic curve, or a cubic curve through nonlinear regression analysis of the growth data by using the environmental conditions as variables.

9. The apparatus of claim 7, wherein the control panel screen comprises a table-presenting selection window that presents as a table a change in growth according to environmental conditions and time intervals based on the growth data.

10. The apparatus of claim 7, wherein the control panel screen comprises a graph-presenting selection window that presents as a graph a change in growth according to environmental conditions and time intervals based on the growth data.

11. The apparatus of claim 7, wherein the control panel screen allows a user to input a plurality of environmental conditions of the virtual living organism so that different changes in growth of the virtual living organism under the plurality of environmental conditions are displayed in a plurality of windows.

12. The apparatus of claim 7, wherein the display comprises a clock that allows a user to recognize a change in growth of the virtual living organism over time.

13. A computer readable recording medium that stores a software program for executing a method of teaching biology by using a virtual living organism that is displayed on a display of a computer, wherein the method comprises:
collecting growth data of an actual living organism according to different environmental conditions at a predetermined time interval and storing the collected growth data in a storage unit;
obtaining a growth equation for each of the different environmental conditions based on the growth data and storing the growth equation;
designing a growth animation of the virtual living organism for each of the different environmental conditions based on the growth equation and storing the growth animation in the storage unit; and
controlling a control panel screen that is displayed on the display to fetch the growth data and the growth animation that are stored in the storage unit and to display a change in growth of the virtual living organism on the display when a user inputs environmental conditions of the virtual living organism on the control panel screen.

14. The computer readable recording medium of claim 13, wherein the growth equation is a regression equation obtained as a sigmoid curve, a growth curve, a quadratic curve, or a cubic curve through nonlinear regression analysis of the growth data by using the environmental conditions as variables.

15. The computer readable recording medium of claim 13, wherein the control panel screen comprises a table-presenting selection window that presents as a table a change in growth according to environmental conditions and time intervals based on the growth data.

16. The computer readable recording medium of claim 13, wherein the control panel screen comprises a graph-presenting selection window that presents as a graph a change in growth according to environmental conditions and time intervals based on the growth data.

17. The computer readable recording medium of claim 13, wherein the growth data are stored as a markup language.

18. The computer readable recording medium of claim 13, wherein the control panel screen allows a user to input a plurality of environmental conditions of the virtual living organism so that different changes in growth of the virtual living organism under the plurality of environmental conditions are displayed in a plurality of windows.

19. The computer readable recording medium of claim 13, wherein the display comprises a clock that allows a user to recognize a change in growth of the virtual living organism over time.
